(19) United States
(12) Patent Application Publication
(10) Pub. No.: US 2006/0271986 A1
(43) Pub. Date: Nov. 30, 2006

(54) Methods, gating devices, and computer program products for determining a noise source in a communication network

(76) Inventor: Mark Vogel, Statesville, NC (US)

Correspondence Address: MYERS BIGEL SIBLEY & SAJOVEC, PO BOX 37428, RALEIGH, NC, 27627, US

(21) Appl. No.: 11/135,194

(22) Filed: May 23, 2005

(51) Int. Cl. H04N 7/173

(52) U.S. Cl. 725/111; 725/100

(57) ABSTRACT

A communication network is operated by attenuating signal transmission on an upstream path between a cable modem and a cable modem termination system (CMTS) during a noise test interval. The attenuation on the upstream path is removed at times outside of the noise test interval.

### BACKGROUND OF THE INVENTION

The present invention relates generally to the field of communication networks, and, more particularly, to community antenna television (CATV) networks.

One aspect of the evolution of cable television has been the development of hybrid fiber coax (HFC) networks. Instead of being based entirely on coaxial cable, HFC networks generally include optical fiber cable between the head end and local serving nodes. Each local serving node typically includes a media translator to convert the optical signal into an electrical signal, which is then carried to customers via traditional coaxial cable spans. Cable television companies, or multiple system operators (MSOs) as they are often called, have upgraded many of their existing coaxial cable networks to HFC to take advantage of reduced maintenance costs and improved bandwidth of the optical fiber cable.

With the growth of the Internet, however, MSOs may seek to leverage their investment in these HFC networks to provide more than just cable television programming. The ubiquitous nature of the HFC based cable television network is advantageous in that high-speed data service may be provided to a large segment of the population without the need to install new network infrastructure. As part of providing customers with data-over-cable service, a cable modem is generally used to modulate and demodulate signals passed between the cable television network and the customer premises equipment (CPE) or hosts.

One problem in CATV systems is noise getting into the reverse path of the HFC network. While noise can get into an HFC system through the hardline portion of the plant, a more common source of noise is in the drop portion of the network and/or in the cabling inside the home. In the past, the presence of noise in the reverse path, i.e., upstream path away from the home, may not have presented a problem because services were generally only one-way. Unfortunately, noise may degrade the speed and/or quality of two-way services, such as video on demand (VOD), data services, and/or voice over Internet Protocol (VoIP). The noise problem may be exacerbated in cable networks because the upstream path combines the upstream signals from all homes served from an optical node and the upstream paths from several optical nodes are often combined. The end result is that the upstream noise from one home can affect the services of thousands of other users who share the same upstream path.

One solution to the problem of noise in the upstream path is to place high-pass filters on the path in homes that do not subscribe to two-way services. Such a filter would block the entire upstream path, thereby reducing or preventing any noise collected within the home from entering the cable network. Unfortunately, this solution does not control ingress of noise from homes with two-way services. In addition, such filters prevent a cable company from allowing customers to self-install new equipment. For example, it is advantageous for cable companies to allow users to purchase two-way equipment and hook the equipment up themselves in their homes. A cable company may be required to make a service call to remove any high-pass filters first before any two-way service equipment may be installed and activated.

Another solution to the problem of noise in the upstream path is to use reverse path monitoring systems that include field modules that are placed at one or more key locations in the distribution portion of the HFC plant. Such a monitoring system may operate by monitoring noise in the reverse path at the head end on a continuous basis. When a node is found to have excessive noise, the system generates an alarm and a technician systematically activates field modules to sectionalize the noise problem to a particular leg of the network. That leg is then shut off and a technician is dispatched to the field to further troubleshoot the noise problem. Unfortunately, this approach involves the use of additional equipment in the head end to communicate with and control the field modules as well as the device that switches between the different nodes served out of the office. Field modules are not generally placed on a per subscriber basis. As a result, placement of the modules may necessitate taking down many subscribers at one time. Because the modules are not respectively associated with subscribers, the reverse paths of one-way subscribers may not be individually blocked and/or turned on for self-installs of new two-way equipment. Another disadvantage is that the activation of a field module typically affects the services of all customers beyond that point in the network, not just a single home. Finally, the activation of a field module is typically not coordinated with the transmission of information from cable modem devices and, therefore, can disrupt those transmissions. This may be a problematic issue when voice data is transmitted inasmuch as it is time sensitive and cannot be retransmitted.

### SUMMARY OF THE INVENTION

According to some embodiments of the present invention, a communication network is operated by attenuating signal transmission on an upstream path between a cable modem and a cable modem termination system (CMTS) during a noise test interval. The attenuation on the upstream path is removed at times outside of the noise test interval.

In other embodiments of the present invention, attenuating signal transmission on the upstream path comprises attenuating a portion of the signal transmission spectrum associated with the upstream path or high-pass filtering signal transmission between the cable modem and the CMTS so as to block signal transmission on the upstream path and to allow signal transmission on a downstream path between the CMTS and the cable modem.

In still other embodiments of the present invention, diplex filters are used to separate the upstream path from a downstream path between the CMTS and the cable modem. Attenuating signal transmission on the upstream path comprises attenuating a portion of the signal transmission spectrum associated with the upstream path or severing the upstream path so as to block signal transmission thereon.

In still other embodiments of the present invention, attenuating signal transmission on the upstream path comprises attenuating signal transmission on the upstream path between the cable modem and the cable modem termination system (CMTS) during the noise test interval responsive to a signal from the CMTS.

In still other embodiments of the present invention, the signal is a Data Over Cable System Interface Specification (DOCSIS) signal.

In still other embodiments of the present invention, the test interval is scheduled based on a defined maintenance schedule.

In still other embodiments of the present invention, the maintenance schedule is a Data Over Cable System Interface Specification (DOCSIS) maintenance schedule.

In still other embodiments of the present invention, the test interval comprises a DOCSIS station maintenance interval for the cable modem.

In still other embodiments of the present invention, the test interval further comprises a time interval between a beginning of the station maintenance interval for the cable modem and a beginning of a station maintenance interval for another cable modem.

In still other embodiments of the present invention, the test interval further comprises a time interval between a beginning of the station maintenance interval for the cable modem and a beginning of a scheduled upstream transmission by the cable modem.

In still other embodiments of the present invention, the test interval further comprises a time interval that is a greater of a first time interval between a beginning of the station maintenance interval for the cable modem and a beginning of a scheduled upstream transmission by the cable modem and a second time interval between an end of a scheduled upstream transmission by the cable modem and an end of the station maintenance interval for the cable modem.

In further embodiments of the present invention, a communication network is operated by sequentially attenuating signal transmission on respective upstream paths between a plurality of cable modems and a cable modem termination system (CMTS) during respective noise test intervals. Attenuation on the respective upstream paths is removed outside of the respective noise test interval. A source of noise in the communication network is determined based on a variation in noise measured in the communication network during the respective noise test intervals.

In still further embodiments of the present invention, sequentially attenuating signal transmission, removing attenuation on the respective upstream paths, and determining the source of the noise are performed responsive to detecting a defined noise level in the communication network.

In still further embodiments of the present invention, the respective test intervals are scheduled based on a defined maintenance schedule.

Although described above primarily with respect to method embodiments of the present invention, it will be understood that the present invention may be embodied as methods, devices, and/or computer program products.

### BRIEF DESCRIPTION OF THE DRAWINGS

Other features of the present invention will be more readily understood from the following detailed description of specific embodiments thereof when read in conjunction with the accompanying drawings, in which:

FIG. 1 illustrates an exemplary communication network architecture in accordance with some embodiments of the present invention;

FIG. 2 is a gating device for use in the communication network of FIG. 1 in accordance with some embodiments of the present invention;

FIG. 3 is a gating element for use in the gating device of FIG. 2 in accordance with some embodiments of the present invention;

FIG. 4 is a gating device for use in the communication network of FIG. 1 in accordance with further embodiments of the present invention;

FIG. 5 is a gating element for use in the gating device of FIG. 4 in accordance with some embodiments of the present invention;

FIG. 6 is a flowchart that illustrates operations for determining a noise source in a communication network in accordance with some embodiments of the present invention;

FIG. 7 is a layout of the upstream bandwidth allocation MAP for a Data Over Cable System Interface Specification (DOCSIS) system;

FIGS. 8A through 8C are timelines that illustrate noise-testing intervals in accordance with some embodiments of the present invention; and

FIG. 9 is a flowchart that illustrates operations used to facilitate initialization of modems in the communication network in accordance with some embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, devices, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

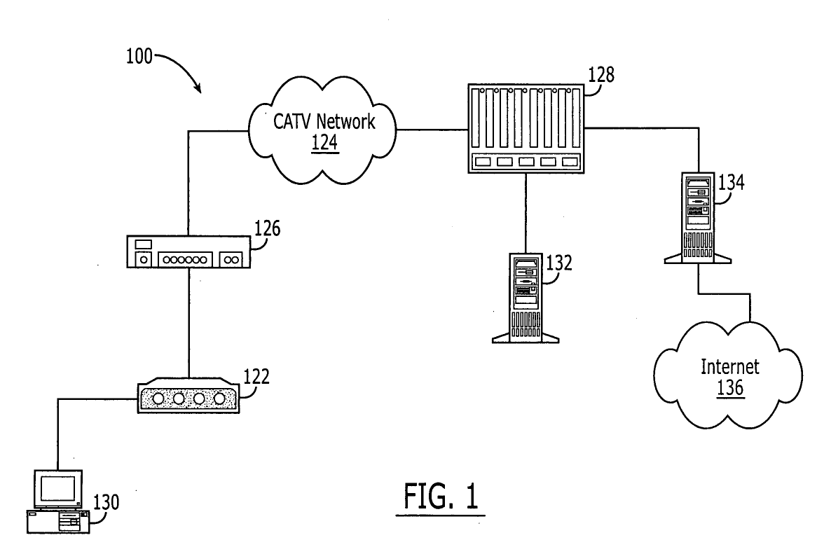

Referring now to FIG. 1, an exemplary communication network architecture 100, in accordance with some embodiments of the present invention comprises, a cable modem 122, which is connected to an external, centralized access television (CATV) or cable network 124 through a gating device 126. The gating device 126 is connected through the CATV network 124 to a head end or cable modem termination system (CMTS) 128. A device, such as a computer 130, may be connected to the cable modem 122.

For purposes of illustration, a gating device 126 is shown connected to the CATV network 124. It is nevertheless understood that a typical CATV network 124 may terminate many gating devices 126 and cable modems 122. The CATV network 124 is typically an HFC network as discussed hereinabove. Moreover, in a conventional multiple service operator (MSO) network, the CMTS 128 may be connected to several CATV networks 124. In some embodiments of the present invention, the gating device 126 is compatible with the Data Over Cable System Interface Specification (DOCSIS). The DOCSIS protocol is a documented open standard that defines how a CMTS and its associated cable modems interact over an HFC network. This includes not only data transmission, but also network management that is based on the Simple Network Management Protocol (SNMP). It is a scheduled protocol in that modems only transmits when they are given the opportunity to transmit. This allows a cable modem to transmit without interference from other cable modems on the same channel.

The CMTS 128 is connected to a dynamic host configuration protocol (DHCP) server 132, which may be accessed to acquire an Internet Protocol (IP) address for networks and subnetworks that are under the control of the CMTS 128. The CMTS 128 is also connected to a router 134, which acts as a gateway/firewall between the CMTS 28 and the Internet 136.

Computer program code for carrying out operations of the CMTS 128, gating device 126, and/or cable modem 122 may be written in a high-level programming language, such as C or C++, for development convenience. Nevertheless, some modules or routines may be written in assembly language or even micro-code to enhance performance and/or memory usage. It will be further appreciated that all and/or part of the functionality of the CMTS 128, gating device 126, and/or cable modem 122 may also be implemented using discrete hardware components, a single application specific integrated circuit (ASIC), or a programmed digital signal processor or microcontroller.

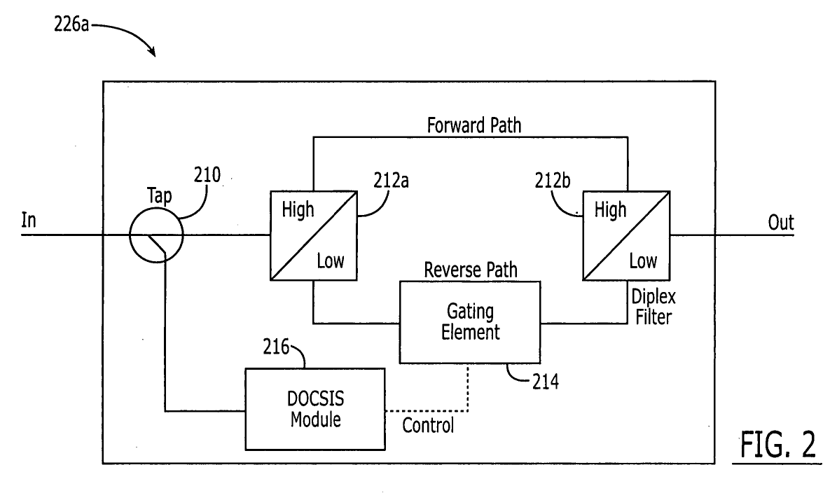

An exemplary gating device 226a that may be used to implement the gating device 126 of FIG. 1, in accordance with some embodiments of the present invention, will now be described with reference to FIG. 2. The gating device 226a comprises a tap 210, a pair of diplex filters 212a, 212b, a gating element 214, and a DOCSIS module 216 that are configured as shown. The tap 210 is used to provide access to the transmission medium for the DOCSIS module 216. The DOCSIS module 216 is configured to control operation of the gating element 214 responsive to DOCSIS signals received from the CMTS 128.

As shown in FIG. 2, the diplex filters 212a, 212b are used to separate the forward or downstream transmission path from the CMTS 128 to the gating device 126 from the reverse or upstream transmission path from the gating device 126 to the CMTS 128. While the use of diplex filters 212a, 212b may introduce loss into the transmission path, the filters 212a, 212b also isolate the forward and reverse paths from each other so that activity on the reverse path is less likely to impact traffic on the forward path.

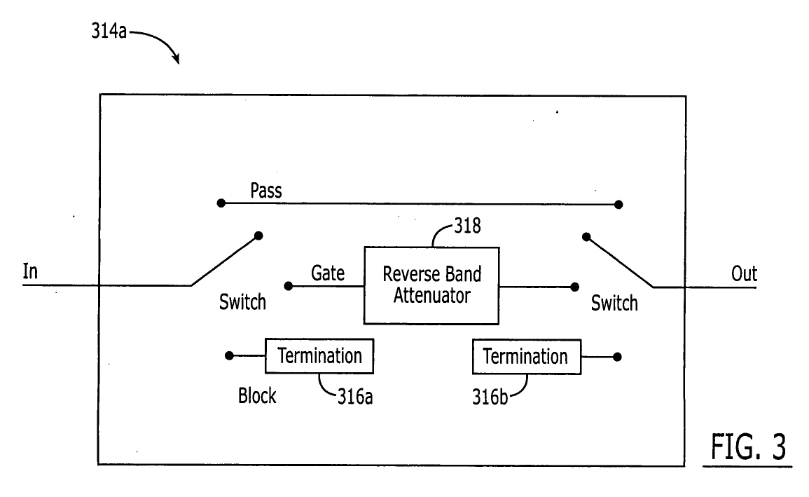

An exemplary gating element 314a that may be used to implement the gating element 214 of FIG. 2, in accordance with some embodiments of the present invention, will now be described with reference to FIG. 3. The gating element 314a comprises two three-position switches that are responsive to a control signal from the DOCSIS module 216 of FIG. 2. In a “pass” position, transmission signals on the reverse path are passed through the gating element 314a using, for example, a 75-ohm line that connects the input path and output paths of the gating element 314a. In a “block” position, the reverse or upstream path from the cable modem 122 to the CMTS 128 is severed through the use of two 75 ohm termination blocks 316a, 316b. This prevents the reverse or upstream path from the cable modem 122 to the CMTS 128 from being the source of noise in the communication network 100. Alternatively, instead of severing the reverse path or completely attenuating signal transmission on the reverse path, it may be desirable to attenuate a portion of the signal transmission spectrum on the reverse path. In the “gate” position, a reverse band attenuator 318 may be used to block or attenuate a portion of the reverse/upstream path signal transmission spectrum. In particular, the reverse band attenuator 318 may filter the lower portion of the signal transmission spectrum as this part of the transmission band is typically noisier. This may allow some two-way cable modem services that use the higher portion of the reverse band spectrum to remain operational while still blocking set-top box transmissions, which may be the source of noise in the lower portion of the reverse path transmission spectrum. As will be discussed in more detail hereafter, either complete blocking of transmission on the reverse/upstream path or attenuation of transmission on the reverse/upstream path may be coordinated with scheduled transmissions for the cable modem 122 based on the DOCSIS protocol.

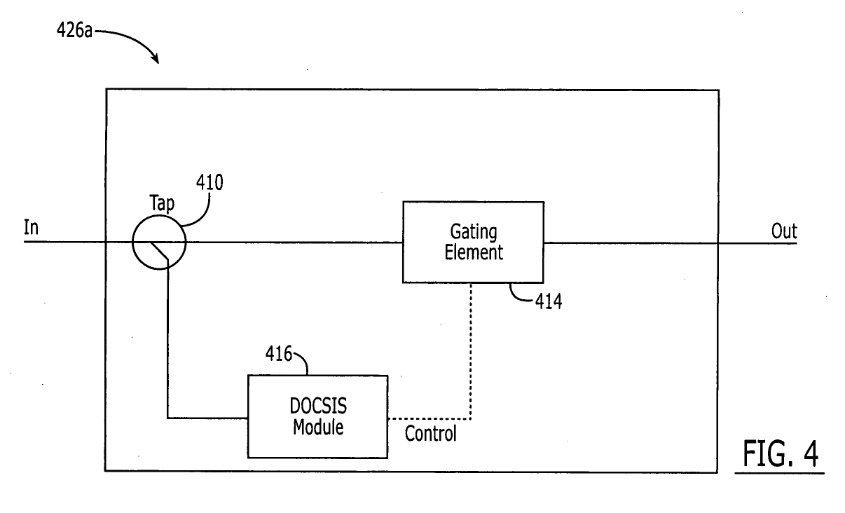

As discussed above, the use of diplex filters 212a, 212b in the gating device 226a of FIG. 2 may introduce loss into the transmission path. An exemplary gating device 426a that may be used to implement the gating device 126 of FIG. 1 without the use of diplex filters, in accordance with some embodiments of the present invention, will now be described with reference to FIG. 4. The gating device 426a comprises a tap 410, a gating element 414, and a DOCSIS module 416 that are configured as shown. The tap 410 is used to provide access to the transmission medium for the DOCSIS module 416. The DOCSIS module 416 is configured to control operation of the gating element 414 responsive to DOCSIS signals received from the CMTS 128.

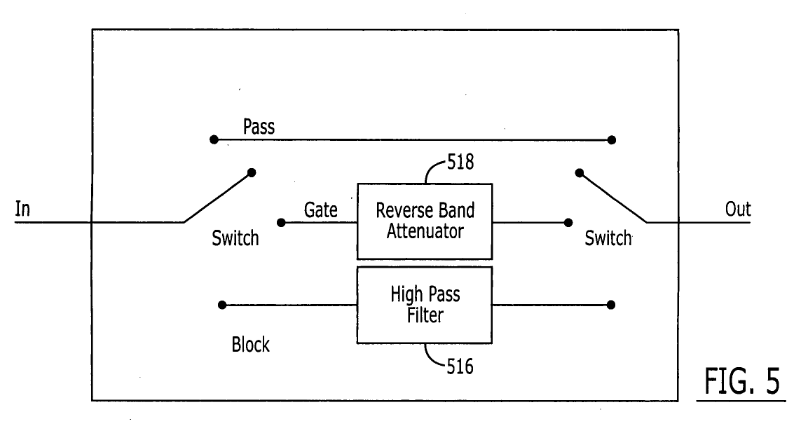

An exemplary gating element 514a that may be used to implement the gating element 414 of FIG. 2, in accordance with some embodiments of the present invention, will now be described with reference to FIG. 5. The gating element 514a comprises two three-position switches that are responsive to a control signal from the DOCSIS module 416 of FIG. 4. The configuration of the gating element 514a is similar to that discussed above with respect to FIG. 3; however, in FIG. 4, a high pass filter 516 is used to block the transmission spectrum associated with the reverse or upstream path. Also, the reverse band attenuator 518 is configured to attenuate or block a portion of the reverse/upstream path signal transmission spectrum without affecting transmission on the forward/downstream path.

Returning to FIG. 1, the gating device 126 can be added to the communication network 100 by a technician placing the device at the network interface to the home after the ground block for the drop. This would place the customer out of service for the duration of the installation. The customer side of the ground block is connected to the input of the gating device 126 and the customer's coaxial wiring is connected to the output of the gating device 126. Because the gating device 126 may be a DOCSIS compatible device, the CMTS 128 may treat the gating device 126 as it would a cable modem. The gating device 126 may be initialized, register with the network, and receive an IP address. At this point the gating device 126 would be fully functional on the network and could be managed by SNMP. The gating device 126 may be configured to be on the same channel as the cable modem or other communication device(s) within the residence it serves. In this way, operation of the gating device 126 may be coordinated with the cable modem's reverse/upstream path transmissions.

Advantageously, the gating device 126, according to some embodiments of the present invention, can provide three operational states to a cable operator: The first state is the pass state in which the “pass” position of the gating element 214 is used to pass signals coming into or leaving a home unaffected through the gating device 126. This state can be used when a customer has two-way services and reverse path noise is not a problem from this location. The second state is the “block” state in which the “block” position of the gating element 214 is used to prevent reverse/upstream path transmissions from the home while allowing forward/downstream path transmissions to pass unaffected. This state may be used when a customer subscribes only to one-way service or when reverse path noise emanating from this location creates a problem for the communication network. As discussed above, the “block” state may also allow some reverse/upstream path transmissions to pass to allow some two-way services to remain operational. Finally, the third state is the “gating” state in which the “gate” position of the gating element 214 is used to attenuate or completely block reverse/upstream path transmissions from the home. This state may be used by the cable operator for brief periods of time to troubleshoot noise sources in the network. Advantageously, placing the gating device 126 into the gating state may be coordinated with scheduled cable modem 122 transmissions through DOCSIS so as to reduce disruptions in the reverse/upstream traffic. The use of the gating state to troubleshoot sources of noise in the communication network 100 will be described in more detail hereafter.

The present invention is described hereinafter with reference to flowchart and/or block diagram illustrations of methods, gating devices, and computer program products in accordance with exemplary embodiments of the invention. It will be understood that each block of the flowchart and/or block diagram illustrations, and combinations of blocks in the flowchart and/or block diagram illustrations, may be implemented by computer program instructions. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

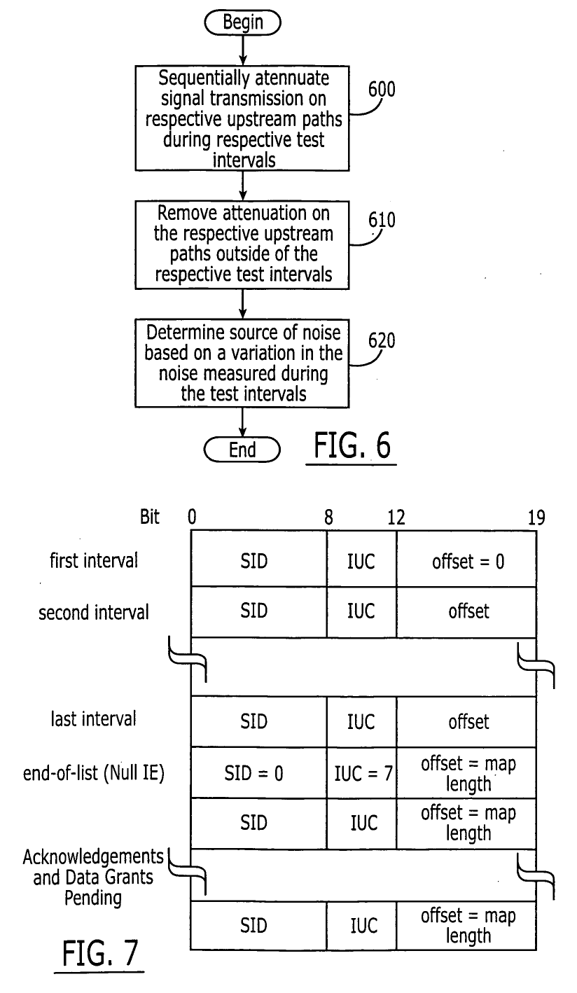

Referring now to FIG. 6, operations for detecting the source of noise in a communication network, in accordance with some embodiments of the present invention, begin at block 600 where the CMTS 128 sequentially uses gating devices 126 to attenuate signal transmission on respective upstream paths from a plurality of cable modems to the CMTS 128 during respective noise test intervals by placing the respective gating devices in the “gating” state or the “block” state. At block 610, the attenuation is removed for each upstream path outside of the associated noise test interval. If the noise emanating from a particular home is large enough, then during the test interval for that home the noise floor will fall, which can be detected at the CMTS 128 through use of a spectrum analyzer, for example. Thus, at block 620, the CMTS 128 may determine a source of noise in the communication network 100 based on a variation in noise measured during the respective test intervals. Note that the source of noise may be from a single location or from multiple locations. Embodiments of the present invention may, therefore, identify a single noise source or a particular geographic area from which noise may be emanating.

As discussed above, the CMTS 128 may coordinate use of the gating device 126 for noise testing with scheduled cable modem 122 transmissions through DOCSIS so as to reduce disruptions in the reverse/upstream traffic. Because the gating device 126 may be a DOCSIS device, the gating device 126 may have access to the upstream transmission schedule of all cable modems on a particular downstream channel through an upstream bandwidth allocation MAP. The layout of the upstream bandwidth allocation MAP is shown in FIG. 7. Each MAP covers a particular period of time and collectively describes all upstream transmissions. In addition, there is a MAP for each upstream channel served by a particular downstream channel.

Through the MAP, the gating device 126 has access to the upstream transmission schedule for all upstream channels associated with a particular downstream channel, the transmission period for any cable modem based on the service ID (SID), and the station maintenance (SM) interval for each cable modem based on the interval usage code (IUC). The upstream transmission schedule may allow coordination of noise testing even if the cable modems are on different upstream channels. The transmission period information, which is obtained based on the SID, allows the CMTS 128 to avoid gating a particular upstream transmission path if the cable modem on that upstream transmission path is scheduled to transmit. The SM interval is a specific upstream transmission interval that is defined by the DOCSIS standard. Every cable modem is directed by the CMTS 128 to perform station maintenance on a regular basis, e.g., at least once every 35 seconds. Station maintenance transmissions are used by the CMTS 128 to adjust the transmission parameters of the cable modem on a periodic basis. The SM interval is a singular transmission opportunity for a modem, meaning that every modem is given a unique upstream time period to perform its station maintenance. Therefore, the CMTS 128 may use the SM interval to gate the cable modem to perform noise testing because it can be assumed that there will be no other upstream transmissions on the channel during this interval. The duration of the SM interval is typically about 10 msec depending on the upstream channel transmission parameters. If this time interval is insufficient to perform noise testing at the CMTS, then the testing interval can be extended.

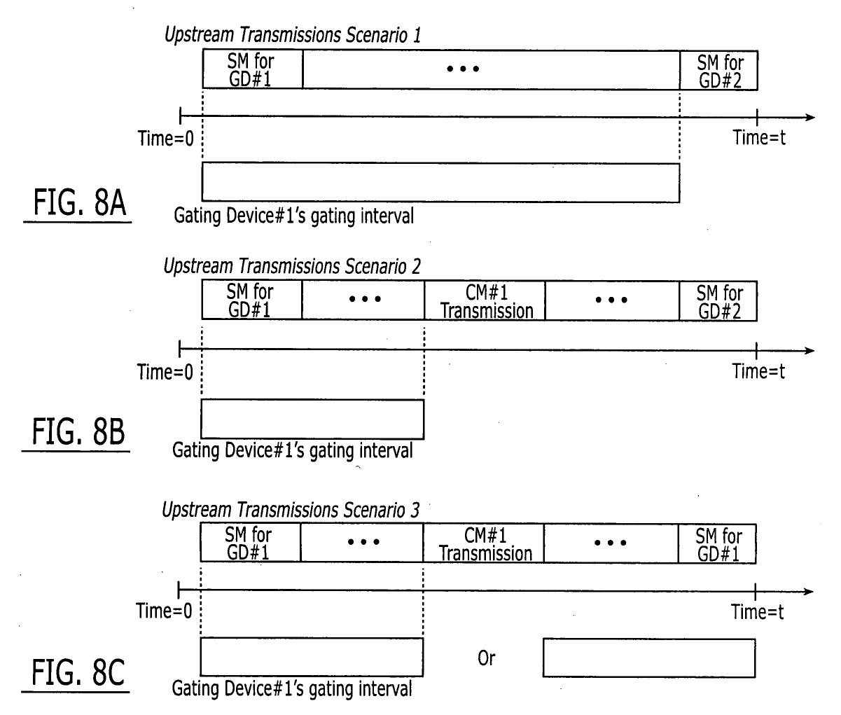

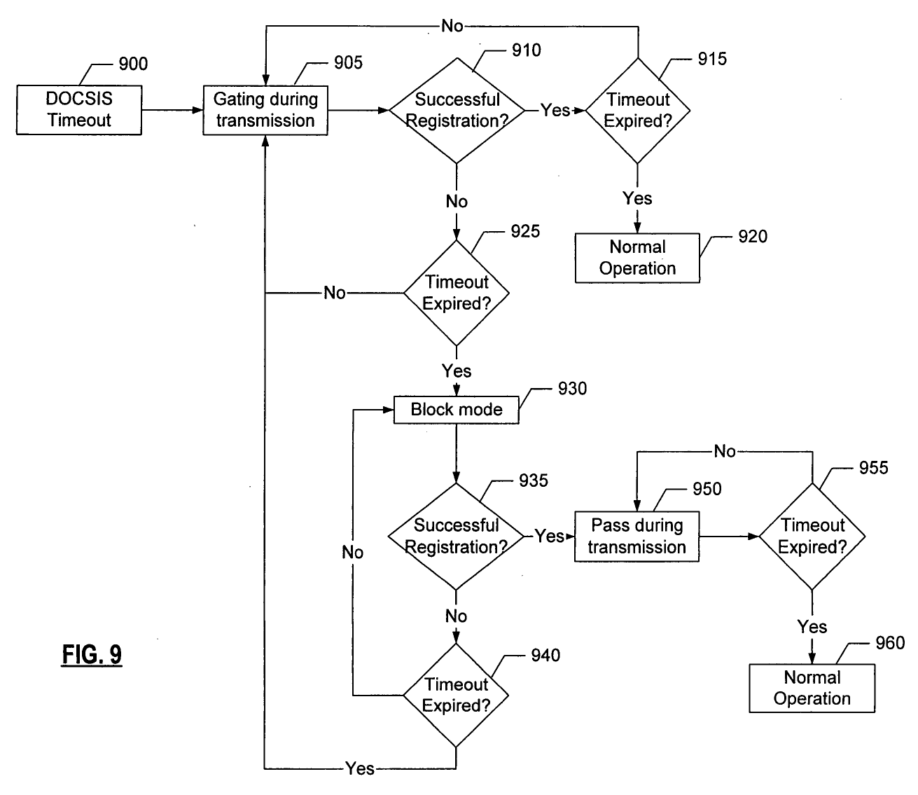

FIG. 8 illustrates three timelines for performing noise testing according to various embodiments of the present invention. In FIG. 8A, noise testing can be performed during the SM interval for a first cable modem and extending to the beginning of a SM interval for a second cable modem. In FIG. 8B, noise testing can be performed during the SM interval for a cable modem and extending to the beginning of a scheduled upstream transmission for that cable modem. In FIG. 8C, noise testing can be performed during the SM interval for a cable modem and may include an additional time interval that is a greater of a first time interval between an end of the SM interval for the cable modem and a beginning of a scheduled upstream transmission by the cable modem and a second time interval between an end of a scheduled upstream transmission by the cable modem and the beginning of the SM interval for the cable modem.

Noise testing can be initiated in various ways. One approach is to initiate noise testing when the CMTS 128 detects excessive noise in the communication network. The CMTS 128 may then cycle through cable modems in the network by using SNMP commands to control gating devices 126 to attenuate/block upstream transmissions to determine which cable modem(s) is the source of the noise as described above. Alternatively, the CMTS 128 may initiate noise testing periodically based on, for example, the DOCSIS protocol. DOCSIS provides for a continuous time stamp known as a SYNC message. This message may be used to schedule periodic noise testing. Alternatively, noise testing may be performed periodically based on SM intervals.

As discussed above, noise testing may be initiated upon detecting noise in a communication network. Noise testing may also be initiated when the noise is severe enough in the communication network to cause modem(s)/DOCSIS modules to go into a DOCSIS-based timeout and to have to re-initialize on the network. For example, if a single home is generating noise in a communication network, then other modems/DOCSIS modules may continually try, but fail to initialize on the network until the noise is reduced or eliminated. Conventionally, a technician may be alerted that there is a mass failure of modems/DOCSIS modules to initialize in the communication network. The technician may then sectionalize the noise problem to a particular leg of the network until the offending home is identified. During the sectionalization process many customers could be placed out of service for an extended period of time.

Advantageously, according to some embodiments of the present invention, the gating device 126 may be used to facilitate initialization of modems in the communication network as illustrated in FIG. 9. As discussed above, a gating device 226a, 426a may comprise a DOCSIS module 216, 416 as shown in FIGS. 2 and 4, respectively. In the embodiments of FIGS. 2 and 4, the DOCSIS module 216, 416 is configured upstream from the gating element 214, 414 allowing the DOCSIS module 216, 416 to communicate with the CMTS 128 regardless of whether the gating element 214, 414 is in the “pass” state, “block” state, or “gating” state. Thus, when noise at one or more locations causes the DOCSIS module(s) at one or more gating device(s) to timeout during initialization at block 900, the gating devices may go into a multi-level recovery mode.

In the first level of the recovery mode, a gating device blocks all upstream signals emanating from the home whenever a DOCSIS module attempts to transmit. On initialization, once a DOCSIS module locks to the downstream and gets all of its upstream transmission parameters, the DOCSIS module begins the ranging process. If there is noise on the communication network, then these ranging transmissions will not be received at the CMTS 128 and, therefore, the DOCSIS module(s) may not be able to register/initialize on the communication network. To overcome this, a gating device will initiate gating during a transmission interval at block 905, which will block all noise from within the location that the gating device serves. Such gating, however, will only be effective for the particular DOCSIS module that serves the location that is the source of the noise because that noise will be present during other gating devices' upstream transmissions. The result is that the only gating device whose DOCSIS module is able to register/initialize at block 910 will be the one that serves the location that is the source of the noise. A technician may then issue an SNMP command to place the gating device into block mode to permanently keep the noise off the communication network until a technician can be dispatched to fix the noise problem. With the noise blocked, the DOCSIS modules of other gating devices may register/initialize on the communication network at block 910. The gating devices will be operating in the recovery-gating mode, however. Thus, after expiration of a timeout period, which may be set by an operator, at block 915, the gating devices may return to normal operation at block 920. In other embodiments, the operator can set all of the gating devices to normal operation through SNMP commands.

It may be the case, however, that more than one location is a source of noise or that the noise is not coming from a particular location, but is instead coming in through the outside plant. In either case, one or more gating devices may be unable to register/initialize on the communication network. When a gating device is unable to register/initialize on the communication network using the gating during transmission recovery mode, another timeout period may expire at block 925 allowing the gating device to enter into a block mode level of recovery at block 930. By blocking all noise coming from all homes, the DOCSIS modules for all of the gating devices may register/initialize on the communication network at block 935. Unfortunately, by blocking all noise from all locations, the sources of the noise may not be determined. After a predetermined time has passed at block 940 to allow all the DOCSIS modules for the gating devices to register/initialize, the gating devices are placed into a pass during transmission mode level of recovery at block 950. In this mode, a gating device allows upstream signals to pass only when it is transmitting. In the CMTS, a monitoring device may continuously monitor the reverse path from a given upstream cluster of nodes. The monitoring device may see a rise in the noise floor of the upstream network when the gating device(s) that are associated with the noise source(s) transmit. Once this is determined, an SNMP command may be used to place the gating device(s) that are associated with noise sources into block mode. A technician can then be dispatched to fix the problem(s). After a timeout period has expired at block 955, the remaining gating devices can be reset to normal operation at block 960 or, in other embodiments, the operator may use SNMP commands to reset the remaining gating devices to normal operation without waiting for the timeout period to expire. If the source of the noise turns out to be a plant issue, the gating devices will timeout at block 900 and reinitiate the recovery process until the problem is fixed or disappears. Advantageously, gating devices, according to some embodiments of the present invention, may register/initialize with a communication network when a noise problem is resolved regardless of whether an operator intervenes through use of SNMP commands.

The flowcharts of FIGS. 6 and 9 show the architecture, functionality, and operation of an exemplary implementation of a communication network including a gating device. In this regard, each block may represent a module, segment, or portion of code, which comprises one or more executable instructions for implementing the specified logical function(s). It should also be noted that in some alternative implementations, the functions noted in the blocks may occur out of the order noted in FIGS. 6 and 9. For example, two blocks shown in succession in FIGS. 6 and 9 may be executed substantially concurrently or the blocks may sometimes be executed in the reverse order, depending upon the functionality involved.

From the foregoing it can readily be seen that embodiments of the present invention may provide a gating device that can be used by a CMTS to facilitate the detection of noise in a communication network. The gating device may be DOCSIS compatible, which may obviate the need for additional equipment in the CMTS to operate the gating device. The CMTS may also communicate with the gating device using SNMP, which is already typically available to communicate with the cable modems.

In concluding the detailed description, it should be noted that many variations and modifications can be made to the preferred embodiments without substantially departing from the principles of the present invention. All such variations and modifications are intended to be included herein within the scope of the present invention, as set forth in the following claims.

That which is claimed:

1. A method of operating a communication network, comprising:
attenuating signal transmission on an upstream path between a cable modem and a cable modem termination system (CMTS) during a noise test interval; and
removing attenuation on the upstream path outside of the noise test interval.

2. The method of claim 1, wherein attenuating signal transmission on the upstream path comprises:
attenuating a portion of the signal transmission spectrum associated with the upstream path; or
high-pass filtering signal transmission between the cable modem and the CMTS so as to block signal transmission on the upstream path and to allow signal transmission on a downstream path between the CMTS and the cable modem.

3. The method of claim 1, further comprising:
using diplex filters to separate the upstream path from a downstream path between the CMTS and the cable modem; and wherein attenuating signal transmission on the upstream path comprises:
attenuating a portion of the signal transmission spectrum associated with the upstream path; or
severing the upstream path so as to block signal transmission thereon.

4. The method of claim 1, wherein attenuating signal transmission on the upstream path comprises:
attenuating signal transmission on the upstream path between the cable modem and the cable modem termination system (CMTS) during the noise test interval responsive to a signal from the CMTS.

5. The method of claim 4, wherein the signal is a Data Over Cable System Interface Specification (DOCSIS) signal.

6. The method of claim 1, further comprising:
scheduling the test interval based on a defined maintenance schedule.

7. The method of claim 6, wherein the maintenance schedule is a Data Over Cable System Interface Specification (DOCSIS) maintenance schedule.

8. The method of claim 7, wherein the test interval comprises a DOCSIS station maintenance interval for the cable modem.

9. The method of claim 8, wherein the test interval further comprises a time interval between a beginning of the station maintenance interval for the cable modem and a beginning of a station maintenance interval for another cable modem.

10. The method of claim 8, wherein the test interval further comprises a time interval between a beginning of the station maintenance interval for the cable modem and a beginning of a scheduled upstream transmission by the cable modem.

11. The method of claim 8, wherein the test interval further comprises a time interval that is a greater of a first time interval between a beginning of the station maintenance interval for the cable modem and a beginning of a scheduled upstream transmission by the cable modem and a second time interval between an end of a scheduled upstream transmission by the cable modem and an end of the station maintenance interval for the cable modem.

12. A method of operating a communication network, comprising:
sequentially attenuating signal transmission on respective upstream paths between a plurality of cable modems and a cable modem termination system (CMTS) during respective noise test intervals;
removing attenuation on the respective upstream paths outside of the respective noise test interval; and
determining a source of noise in the communication network based on a variation in noise measured in the communication network during the respective noise test intervals.

13. The method of claim 12, wherein sequentially attenuating signal transmission, removing attenuation on the respective upstream paths, and determining the source of the noise are performed responsive to detecting a defined noise level in the communication network.

14. The method of claim 12, further comprising:
scheduling the respective test intervals based on a defined maintenance schedule.

15. The method of claim 14, wherein the maintenance schedule is a Data Over Cable System Interface Specification (DOCSIS) maintenance schedule.

16. A gating device, comprising:
a control module that is configured to generate a control signal responsive to a signal from a cable modem termination system (CMTS); and
a gating element comprising a switch that is operable to attenuate signal transmission on an upstream path between the CMTS during a noise test interval and to remove attenuation on the upstream path outside of the noise test interval.

17. The gating device of claim 16, wherein the switch is configured to attenuate a portion of the signal transmission spectrum associated with the upstream path in a first position and to high-pass filter signal transmission between the cable modem and the CMTS so as to block signal transmission on the upstream path and to allow signal transmission on a downstream path between the CMTS and the cable modem in a second position.

18. The gating device of claim 16, further comprising:
diplex filters that are configured to separate the upstream path from the downstream path between the CMTS and the cable modem; and
wherein the switch is configured to attenuate a portion of the signal transmission spectrum associated with the upstream path in a first position and to sever the upstream path so as to block signal transmission thereon in a second position.

19. The gating device of claim 16, wherein the signal from the CMTS is a Data Over Cable System Interface Specification (DOCSIS) signal.

20. A computer program product for operating a communication network, comprising:
a computer readable storage medium having computer readable program code embodied therein, the computer readable program code comprising:
computer readable program code configured to attenuate signal transmission on an upstream path between a cable modem and a cable modem termination system (CMTS) during a noise test interval; and
computer readable program code configured to remove attenuation on the upstream path outside of the noise test interval.

21. The computer program product of claim 20, wherein the computer readable program code configured to attenuate signal transmission on the upstream path comprises:
computer readable program code configured to attenuate a portion of the signal transmission spectrum associated with the upstream path; or
computer readable program code configured to high-pass filter signal transmission between the cable modem and the CMTS so as to block signal transmission on the upstream path and to allow signal transmission on a downstream path between the CMTS and the cable modem.

22. The computer program product of claim 20, further comprising:
computer readable program code configured to use diplex filters to separate the upstream path from a downstream path between the CMTS and the cable modem; and wherein the computer readable program code configured to attenuate signal transmission on the upstream path comprises:
computer readable program code configured to attenuate a portion of the signal transmission spectrum associated with the upstream path; or
computer readable program code configured to sever the upstream path so as to block signal transmission thereon.

23. A method of operating a communication network comprising a plurality of gating devices, each gating device comprising a Data Over Cable System Interface Specification (DOCSIS) module connected in series between an associated gating element and a cable modem termination system (CMTS), comprising:
determining that at least one of the DOCSIS modules is unable to initialize on the communication network;
configuring the gating elements so as to block transmission to the CMTS during intervals that DOCSIS modules transmit to the CMTS, respectively.

24. The method of claim 23, further comprising:
identifying a source of noise in the communication network based on one of the DOCSIS modules being able to initialize on the communication network when the gating element associated with the one of the DOCSIS modules is configured to block transmission.

25. The method of claim 23, further comprising:
determining the existence of multiple noise sources in the communication network based on multiple DOCSIS modules being unable to initialize on the communication network;
configuring the gating elements so as to block transmission to the CMTS at all times;
initializing the DOCSIS modules on the communication network;
configuring the gating elements so as to allow transmission to the CMTS only when the gating device transmits after the DOCSIS modules have initialized; then monitoring the noise in the communication network to identify a rise in the noise floor when at least one gating device that is associated with the noise source transmits.
